(19) United States
(12) Patent Application Publication
(10) Pub. No.: US 2008/0097924 A1
(43) Pub. Date: Apr. 24, 2008

(54) DECENTRALIZED SECURE TRANSACTION SYSTEM

(75) Inventors: Todd A. Carper, San Francisco, CA (US); Hampton Miller, Corvallis, OR (US)

Correspondence Address: PAUL, HASTINGS, JANOFSKY & WALKER LLP, 875 15th Street, NW, Washington, DC, 20005, US

(73) Assignee: Electronic Plastics, LLC, Las Vegas, NV (US)

(21) Appl. No.: 11/876,125

(22) Filed: Oct. 22, 2007

Related U.S. Application Data
(60) Provisional application No. 60/862,381, filed on Oct. 20, 2006.

(51) Int. Cl. G07F 7/10; G06K 17/00

(52) U.S. Cl. 705/65; 235/380; 235/492

(57) ABSTRACT

A secure transaction system in accordance with one exemplary embodiment comprising a terminal; a secure access module coupled to the terminal; and a secure embedded device coupled to the secure access module during a transaction; wherein the business logic for controlling flow of the transaction is contained within the secure access module and the secure embedded device.

### RELATED APPLICATIONS

This application claims priority to U.S. Provisional Patent Application No. 60/862,381, filed Oct. 20, 2006, entitled DECENTRALIZED SECURE TRANSACTION SYSTEM, to Carper, et al. which is incorporated herein by reference in its entirety.

### BACKGROUND OF THE INVENTION

1. Field of the Invention

The present invention relates to decentralized secure transaction systems. More specifically, the present invention relates to the architecture and design of the components utilized in providing a decentralized secure transaction system.

2. Discussion of the Related Art

Transaction systems, such as, for example, financial transaction systems, identification systems, and access control systems (e.g., electronic key systems) are used throughout the world. One such system is a standard credit card system. Shown in FIG. 1 is a magnetic stripe system such as is used in today's typical credit card system utilized today. Shown are a terminal 100, a magnetic stripe reader 102, and a back end 106. In operation, the amount of the transaction is entered into the terminal 100 and displayed on a screen of the terminal 100. Following, a credit card 104 is run through the magnetic stripe reader 102. The information from the credit card 104 is read by the terminal 100 which then initiates a dial-up call to the back end 106. The terminal 100 sends the credit card number, a store number and an amount for the transaction to the back end 106. The back end 106 includes processing business logic and a database. The database preferably contains current information on the status of the account such that the processing business logic can determine whether to approve the requested transaction. Once approved, the back end 106 sends an authorization code to the terminal 100 and the transaction is completed. Credit card systems have many known flaws and are generally not considered to be secure systems. Account numbers and personal information are easily readable on the front of the card and from the magnetic stripe. Furthermore, these systems usually require a connection to a back end database in order to verify and approve a transaction. The back end databases are located around the world and information must be periodically propagated from one database to another in order to keep the system up to data and able to properly approve a transaction. Thus, information about an account may not be current in some of the databases, which can lead to approving some transactions that may otherwise be declined or declining transactions that should be approved.

Another current financial transaction system is shown in FIG. 2. Shown is a Security Authentication Module (SAM) unit 200, a smart card 202 and a smart terminal 204. The SAM unit 200 includes a plurality of slots that can received SAM cards used for different banking systems (e.g., EMVCo, Visacash, and Proton). The smart terminal 204 in current financial transaction systems is generally a very sophisticated device. That is, the smart terminal 204 contains the business logic for the transaction and is required to make decisions regarding the process flow of the transaction. In operation, the terminal will request information for the SAM unit 200 and/or the smart card 202. The SAM unit 200 and/or the smart card 202 will reply to the message; however, the SAM unit 200 and the smart card 202 do not make any decisions about how the process flow proceeds. The smart terminal 204 controls all of the process flow, which may or may not depend upon the answers it receives from the SAM unit 200 and/or the smart card 202. In this manner, the smart terminal 204 must have knowledge about the types of messages it is expecting from the SAM unit 200 and/or the smart card 202 and how to interpret the information from the SAM unit 200 and/or the smart card 202 in order to function properly. Thus, the smart terminal 204, which in not necessarily a secure device, is a vulnerable point of attack in the system and can be used to determine information about the transaction systems business logic and information about the SAM unit 200 and/or the smart card 202. While manufactures of Smart Cards and SAM's are very good with secure communications and cryptography, often, the software programmers of the terminals tend to not be good with cryptography and improperly program the terminals.

In current systems, the smart terminal 204 has a variety of problems that make it undesirable and/or susceptible to attack. First, the smart terminal 204 is generally a computer with a large amount of processing capabilities. A typical terminal can easily cost $600 or more. Furthermore, the smart terminal 204 generally needs to be compatible with a variety of different financial systems. For example, EMVCo, Visacash, and Proton are three well known financial systems. The smart terminal 204 must be programmed to implement the business logic of each of the financial systems. Anytime the business logic changes, the terminal must be reprogrammed. Thus, changes in the business logic can be expensive to implement and take time to propagate to every terminal. Furthermore, because the smart terminal 204 contains the business logic and directs communications within the system, the smart terminal 204 must be given sensitive information needed for the transaction. Thus, sensitive information is available to the terminal and thus, potentially can be compromised. It is important to note that during the transaction, the smart terminal 204 is controlling the process and asking the smart card 202 and the SAM unit 200 for information. The smart card 202 and the SAM 200 only reply to questions or do what the smart terminal 204 instructs them to do.

Therefore, the current financial transaction systems have a great number of problems that lead to potential security weak points and an increase in the cost of the smart terminal 204 and thus, the overall financial transaction system.

### SUMMARY OF THE INVENTION

Some of the present embodiments provide for improved secure transaction systems. Additionally, some of the embodiments herein provide for improved encryption and decryption systems and methods.

One embodiment can be characterized as a secure transaction system comprising a terminal; a secure access module coupled to the terminal, wherein the secure access module includes a first set of business rules for performing a transaction; and a secure embedded device coupled to the secure access module during the transaction, wherein the embedded device includes a second set of business rules for performing the transaction; wherein the terminal routes messages between the secure access module and the secure embedded device.

Another embodiment can be characterized as a secure transaction system comprising a terminal; a secure access module coupled to the terminal; and a secure embedded device coupled to the secure access module during a transaction; wherein the business logic for controlling flow of the transaction is contained on the secure access module and the secure embedded device.

Yet another embodiment includes a method of performing a secure transaction comprising detecting a secure embedded device that has been coupled to a terminal; sending an operate command from the terminal to a secure access module; executing, at the secure access module, a first set of business rules and generating a first message for the secure embedded device, wherein the first message might be at least partially encrypted; sending the first message to the secure embedded device; executing, at the secure embedded device, a second set of business rules in response to receiving the first message and generating as second message for the secure access module, wherein the second message is at least partially encrypted; and sending a command to the terminal indicating to the terminal to perform an intended function.

Another embodiment can be characterized as a method of updating a device in a transaction system comprising coupling a secure access module to a terminal; coupling a secure embedded device to the terminal; receiving a message from the secure access module at the secure embedded device; and updating at least one business rule of the secure embedded device in response to receiving the message.

One subsequent embodiment can be characterized as a method of updating a device in a transaction system comprising coupling a secure access module to a terminal; coupling a back end to the terminal; receiving a message from the back end at the secure access module; and updating at least one business rule of the secure access module in response to receiving the message.

Another alternative embodiment includes a method of updating a device in a transaction system comprising coupling a secure access module to a terminal; coupling a secure embedded device to the terminal; coupling a back end to the terminal; receiving a message from the back end at the secure embedded device; and updating at least one business rule of the secure embedded device in response to receiving the message.

Yet another embodiment includes a method of communication comprising creating a data structure in an first application layer, the data structure indicating to a first transport layer a list of addresses that correspond to data stored in a first device and an indication of whether the data located at the list of addresses will be sent to a second transport layer in encrypted or unencrypted form; sending the data in the list of addresses from the first transport layer to the second transport layer in unencrypted or encrypted form as indicated in the data structure; storing the data sent from the first transport layer in memory of a second device; and decrypting the data in a second application layer.

### BRIEF DESCRIPTION OF THE DRAWINGS

The above and other aspects, features and advantages of the present invention will be more apparent from the following more particular description thereof, presented in conjunction with the following drawings, wherein:

FIG. 1 is a diagram illustrating a magnetic stripe transaction system;

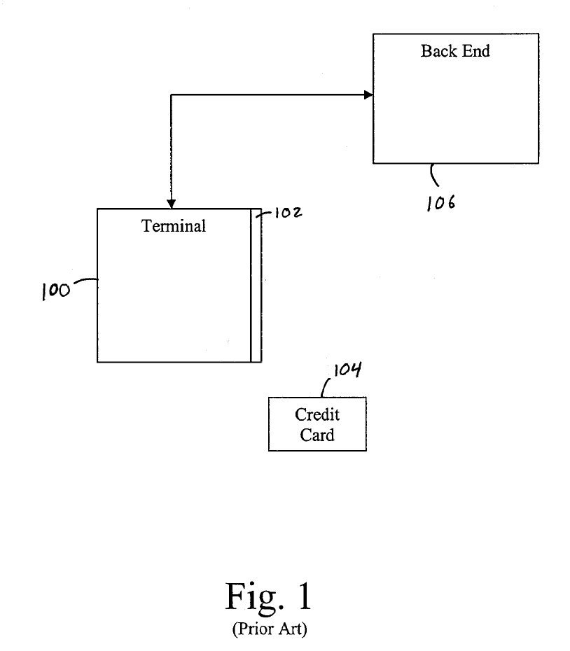

FIG. 2 is a diagram illustrating a smart card financial transaction system;

FIG. 3 is a block diagram illustrating a transaction system in accordance with one embodiment;

FIG. 4 is a block diagram illustrating a financial transaction system in accordance with one embodiment;

FIG. 5 is a block diagram illustrating an access control transaction system in accordance with one embodiment;

FIG. 6 is a diagram illustrating a hierarchy within the access control transaction system shown in FIG. 5 in accordance with one embodiment;

FIG. 7 is a diagram illustrating a possible structure of an access level within the hierarchy of the access control transaction system shown in FIG. 6 in accordance with one embodiment;

FIG. 8 is a diagram illustrating a rule for the access block shown in FIG. 7 in accordance with one embodiment;

FIG. 9 is a diagram illustrating a bit table for use in the access control transaction system shown in FIG. 5 in accordance with one embodiment;

FIG. 10 is a diagram illustrating a message block used in a transaction system in accordance with one embodiment;

FIG. 11 is a diagram illustrating a system for encrypted communication in accordance with one embodiment; and

FIG. 12 is a diagram illustrating a table for use in the system shown in FIG. 11 in accordance with one embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions, sizing, and/or relative placement of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

The following description is not to be taken in a limiting sense, but is made merely for the purpose of describing the general principles of the invention. The scope of the invention should be determined with reference to the claims. The present embodiments address the problems described in the background while also addressing other additional problems as will be seen from the following detailed description.

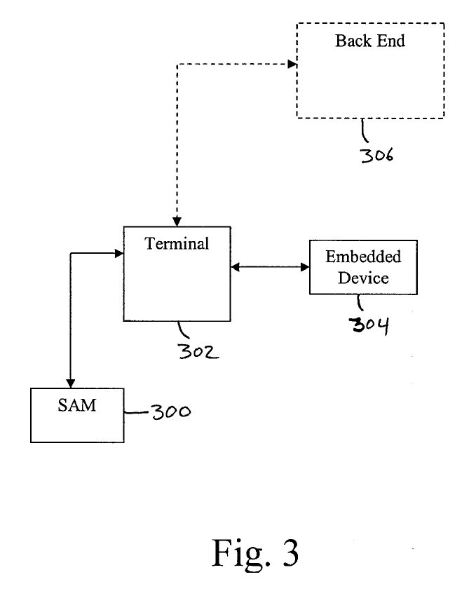

Referring to FIG. 3, a block diagram is shown illustrating a transaction system in accordance with one embodiment. Shown is a SAM unit 300, a terminal 302, an embedded device 304 and a back end 306.

The SAM unit 300 and the embedded device 304 are both very secure devices. The SAM unit 300 and the embedded device 304 include secure processors that are manufactured in such a manner that data and any applications located on the SAM unit 300 or the embedded device 304 can not be readily accessed. Such methods of manufacturing a secure processor are known to those of ordinary skill in the art. Thus, the SAM unit 300 can also be referred to as a secure SAM and the embedded device 304 can also be referred to as a secure embedded device.

As described herein a processor is a circuit or circuitry including, for example, either dedicated or fixed purpose hardware and/or a partially or fully programmable platform. Additionally, as described herein, a processor can include hardware, firmware, and/or software functioning alone or in combination. In one embodiment, the processor includes an operating system and memory for storing one or more executable applications. One example of an embedded device having a processor that includes an operating system and executable application that can be utilized in accordance with various embodiments described herein is described in U.S. Pat. No. 6,390,374, issued May 21, 2002, to Carper et al., entitled SYSTEM AND METHOD FOR INSTALLING/DE-INSTALLING AN APPLICATION ON A SMART CARD, which patent is incorporated herein by reference in its entirety. By utilizing a device with a true operating system for the SAM 300 and the embedded device 302, the potential applications and versatile functionality of the transaction systems described herein can be fully realized. Such functionality can not be implemented in current systems where the terminal alone is implementing the business logic of the system. A biometric embedded device that can be utilized in accordance with various embodiments described herein is described in U.S. Provisional Patent Application No. 60/806,494, filed Jul. 3, 2006, to Carper et al., entitled BIOMETRIC EMBEDDED DEVICE, which provisional application is incorporated herein by reference in its entirety.

The back end 306 is optional for many applications, however, can provide beneficial features in, for example, financial and access control systems. The back end 306 is generally located in a very secure location and is not a problem area for a breach of security in most transaction systems. Additionally, the back end 306 can incorporate the program and architecture of the embedded device 304 and the SAM 300 (i.e., include a secure processor) or can operate as a general purpose computer system capable of processing encrypted messages in accordance with the message format utilized by the SAM 300 and the embedded device 304.

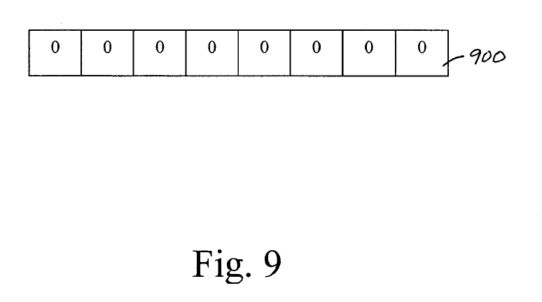

The terminal 302, in accordance with some embodiments, is a very basic device that has limited functionality. The terminal 302 potentially includes limited interface features such as a display and/or entry keys. Additionally, the terminal 302 can send and receive basic information such as, for example, time, date, amount of transaction, or other basic information to the SAM unit 300. The terminal 302 is also capable of routing messages between the SAM unit 300, the embedded device 304 and the back end 306 (when present). While the terminal 302 can route messages, the terminal 302 is generally not capable of reading the content of the message unless the message is meant for the terminal 302. That is, the terminal 302 can not decrypt messages sent between any of the SAM 300, the embedded device 304, and the back end 306. The terminal 302 is enabled with neither the capability nor the keying information necessary to determine the meaning of the messages. This keeps the terminal 302 from having any knowledge about the operation of the secure devices within the system and keeps the system free from having the terminal 302 as an attack point within the transaction system. An exemplary message format in accordance with some embodiments is described below with reference to FIG. 9. The message includes an unencrypted routing portion and an encrypted portion. The unencrypted routing portion of the message allows the terminal to properly route the message to an intended recipient.

The terminal 302 communicates with the embedded device 104 over any interface such as is known in the art. The interface provides input/output (I/O) functions between the embedded device 304 and the terminal 302 and also optionally provides power from the terminal 302 to the embedded device 304. The interface can be a wired or wireless interface such as is known to one of ordinary skill in the art.

The terminal 302 can be, for example, a SmartCard reader, an access control terminal, a soda dispensing machine, a parking meter, or many other types of terminals. The terminal 302 can be utilized for many different applications, such as, for example, financial transactions, authorization for entry, identification, access control, or many other types of applications. The terminal 302 also communicates with the SAM unit 300 or other type of secure processor.

The embedded device 304 is, for example, a SmartCard, a USB flash card, or other type of portable integrated circuitry that is embedded within or mounted on a casing and capable of communicating with the device reader 100. In an alternative embodiment, the embedded device 104 includes integrated circuitry that is coupled to a flexible substrate (e.g., a bracelet or watch band) and/or a wearable device, such as, for example, a watch, necklace or badge. In some embodiments, the portable integrated circuitry includes a secure processor that includes an operating system and memory for storing one or more executable applications.

In operation, in accordance with one embodiment, before the embedded device 304 is connected to the terminal 302, the terminal 302 and the SAM unit 300 (also referred to herein as the SAM 300) are powered on. Following, an Answer to Reset message (ATR) is sent from the SAM 300 to the terminal 302. Optionally, the SAM 300 will provide the terminal 302 with the SAM's public key. Next, the terminal 302 will detect when the embedded device 304 comes into communication with the terminal 302 (e.g., through a wired or wireless interface). In many instances, the embedded device 304 will be inserted into the terminal 302 and metal contacts will provide power and I/O connections to the embedded device 304. Alternatively, the embedded device includes an onboard power source such as a battery or solar cell. Still alternatively, a wireless interface is provided between the terminal 302 and the embedded device 304. The wireless interface provides both I/O functions and power to the embedded device 304. Optionally, the SAM 300 and the embedded device 304 will exchange their public keys at this time. Optionally, the SAM and the embedded device may utilize a symmetric key cryptographic model and will have previously established a shared secret. Upon detection of the embedded device 304, the terminal 302 will send an “operate” command to the SAM 300. The operate command informs the SAM 300 that an embedded device 304 (e.g., a smart card) is connected to the terminal 302. Along with an operate command, the terminal 302 also sends general information to the SAM 300, such as a time stamp, a dollar amount of the transaction, or other general information that is needed depending upon the type of transaction that the terminal 302 is designed for.

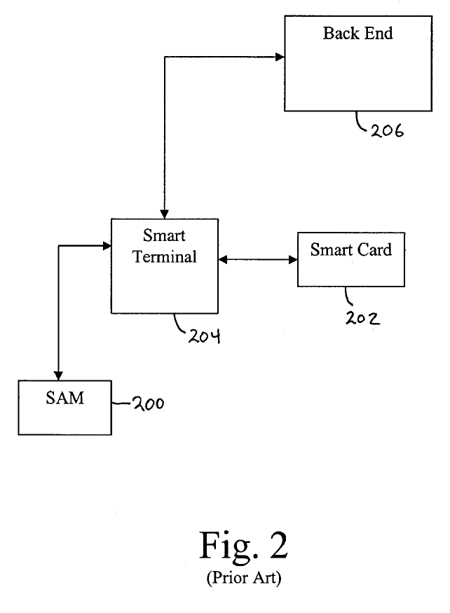

Next, in accordance with one embodiment, the SAM 300 uses business rules that are located on the SAM 300 to create an encrypted message for the embedded device 304. The SAM 300 encrypts the message using the public key of the embedded device 304 such that the embedded device 304 can decrypt the message using a private key that is stored on the embedded device 304. Because the embedded device 304 is secure, the private key is not accessible to anyone except the embedded device 304. In another embodiment, the SAM and embedded device will utilize a shared secret instead of a public/private key exchange. As will be described in greater detail herein with reference to FIG. 9, the message includes routing information that is not encrypted such that the terminal 302 can route the message from the SAM 300 to the embedded device 304. The terminal 302 can not read the message and has no information as to the content of the message. This is in contrast to the prior art systems where the terminal 302 includes the business logic for the transaction system. In prior systems (e.g., the system of FIG. 2), the terminal requests information from the SAM and the smart card and must be able to read the content of the messages in order to determine the next step to take. This determination may depend upon the content of the message and the business logic of the terminal. In the present embodiment however, the routing information that is generated by the SAM 300 instructs the terminal 302 where to send the message. Thus, the terminal 302 does not include any business logic, but is only routing messages upon direction from the SAM 300. Additionally, it should be noted that in prior systems the SAM and the smart card do not dictate the business logic for the transaction but are only responding to inquires from the terminal. Thus, in accordance with the present embodiments, the business logic for the system is now performed by a secure processor (e.g., the SAM 300, the embedded device 304 and the back end 306 which is secure because of its secure location) rather than in the terminal 302 which is not a secure device.

In each of the embodiments, the devices (SAM, Card, back-end, or other embedded device) rules that are previously loaded into each device dictate how the device reacts to various business scenarios. The combination of these rules comprises the business logic and business information flow for those systems in which the embedded devices are authenticated to participate. The business logic, subsequently defined by rules, includes, for example, such definitions as whether the balance may be viewed, daily spending limit, maximum transaction amount, requirement of an additional biometric and/or PIN authentication prior to allowing a transaction, and permitting transaction during specific hours of the day. This system is in contrast to conventional systems where the SAM and embedded devices simply respond to requests from the terminal which is defining the business logic of the system. In such conventional systems, the terminal is programmed with the rules. Thus, simple examination of the terminal can reveal the types of messages that are being requested from the SAM or the embedded devices which creates a weak point in conventional systems.

One aspect of the present embodiments allows each rule to contain information regarding the type of rule processor which must be available to evaluate the rule. Whereas a rule typically consists of a sequential list of symbolic references to a library of built-in resources (plus literal operands or symbolic references to operands), some rules may include actual low-level machine instructions. This permits rules to be developed in any existing programming language as well as future programming languages and systems that may become prevalent. Presently, by way of example, rules are created using java, C, Forth, Assembly Language and the appropriate processing routine, if necessary, is developed and loaded into the embedded device.

In one embodiment, after the embedded device 304 receives the message from the SAM 300 that has been routed by the terminal 302, the embedded device 304 decrypts the message and executes its own business logic. Depending upon the outcome of the business logic, the embedded device 304 will, for example, send an encrypted message back to the SAM 300. The SAM 300 and the embedded device 304 can continue to send messages back and forth or send messages to the back end 306 depending upon the business logic located on the SAM 300, the embedded device 304 and the back end 306 (if present). During the entire transaction, the terminal 302 is responsible for routing messages, but does not need to make any business logic decisions regarding the transaction. At the end of the transaction, the SAM 300 will generally send a receipt to the terminal 302 in order to memorialize the transaction. The receipt will contain information informing the terminal as to the result of the request as well as containing an encrypted and digitally signed version of the transaction for reporting to the back end for logging purposes. The command will vary greatly depending upon the nature of the transaction. For example, after a transaction is approved, the terminal can print a receipt, dispense a soda can from a soda machine, unlock a door, or add time to a parking meter. The receipt that is sent to the terminal 302 will be logged and optionally will be sent to the back end 306. The receipt can be encrypted or not encrypted depending upon the sensitivity of the record. In one embodiment, when the receipt is not encrypted, a digital signature is added to the receipt that ensures the record is not changed and that the receipt is generated by a proper authority within the system.

In addition to running the business logic of the transaction system, in accordance with one embodiment, the SAM 300 and the embedded device 304 can be updated at any time to include additional business logic or change the business logic. In general, the SAM 300 can be updated through receiving a message from the back end 306. The embedded device 304 can have its business logic updated either by the SAM 300 or the back end 306. Any changes in the business logic of the SAM 300, the embedded device 304 or the back end 306 will take place without the terminal having any knowledge that such an update has taken place. As an example, in operation, when the embedded device 304 is connected to the reader, the SAM 300 or the back end 306, depending upon the flow of messaging, can send a message to the embedded device. The terminal routes the message as it would any other message. However, the message can be an update of the business rules that the embedded device 304 will run. The embedded device can verify that the message came from a trusted source and thus, will implement the change in the business rules. This leads to unlimited flexibility within any implementation of a transaction system, as the flow of the transaction and the required steps to verify the user and complete the transaction can be updated at any time without the need for the user of the device to even know the update has occurred. In prior transaction systems, any update to the business logic had to take place in the unsecured terminal which the issuer of the card did not have control over. The new transaction system solves this problem by actively enforcing issuer control at all times and at all locations.

The system described above with reference to FIG. 3 can be utilized in a large number of different applications including, for example, Access Control, Electronic Cash, Banking, Digital file protection, Digital Rights Management, Key to start an automobile or machinery, Transit card, Parking meter card, Driver License, Passport, Airline ticket validation, Access and usage of carts at a golf course, gambling, and Customer loyalty programs.

In accordance with one embodiment, the system described in FIG. 3 and the systems described below can operate without a session type environment. As an example, financial systems today operate in a “session” environment. That is, the system must keep track of what has happened in the past as the exchange of information takes place. In a smart card system, if the card is accidentally removed from the terminal during the session, the terminal must go through an error handling process and the session will terminate. If the card is reinserted the entire transaction must start over with a new session. However, in the current system, the messages that are sent between the back end 306, the SAM 300 and the embedded device 304 contain all the information that is needed to continue a transaction. In this manner, the SAM 300, the embedded device 304 and the back end 306 do not need to keep track of what previous messages or steps were taken in the system. The messages will contain any information that the SAM 300, the embedded device 304 and the back end 306 need to proceed with the transaction. Having a system that does not require a session removes the strain on a system that takes place when your system becomes very large in scale (such as financial systems and large access control systems). In systems that require a session, the back end can be required to keep track of millions of sessions, thus leading to strain upon the system.

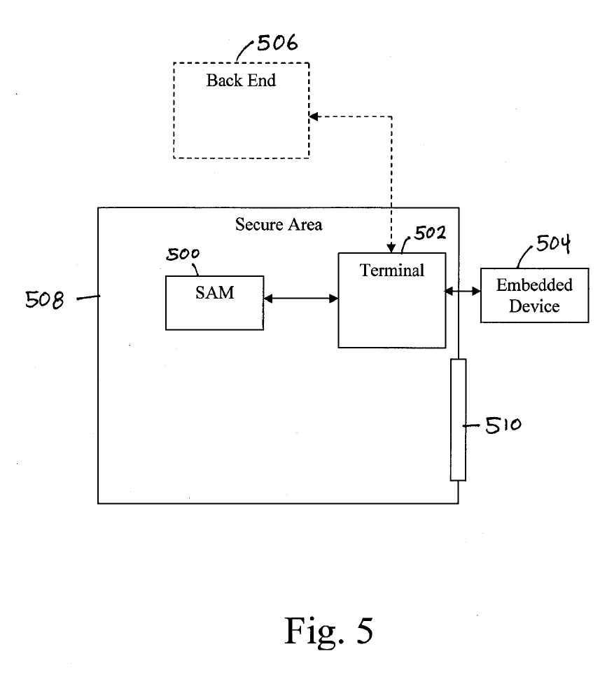

Thus, for example, a financial system that does not require a session removes the need for the back end to maintain a history of what is happening for millions of current transactions that are taking place. A sessionless access control system can also have added functionality and benefits as will be described below with reference to FIG. 5. In accordance with one embodiment, in order for the system to be “sessionless” each message carries with it all of the state information required to perform the desired operation. However, so as to not reveal any of this information to a potential adversary monitoring communications between the various parts of the system, all information not required to route the message to its proper destination is encrypted. Thus, the message format reduces to a single byte of routing information followed by an opaque block of encrypted information which may be of any length. A feature of the system described herein, in accordance with various embodiments, is that each message is specifically encrypted in such a manner that only its intended recipient possesses the knowledge required to decrypt the message contents.

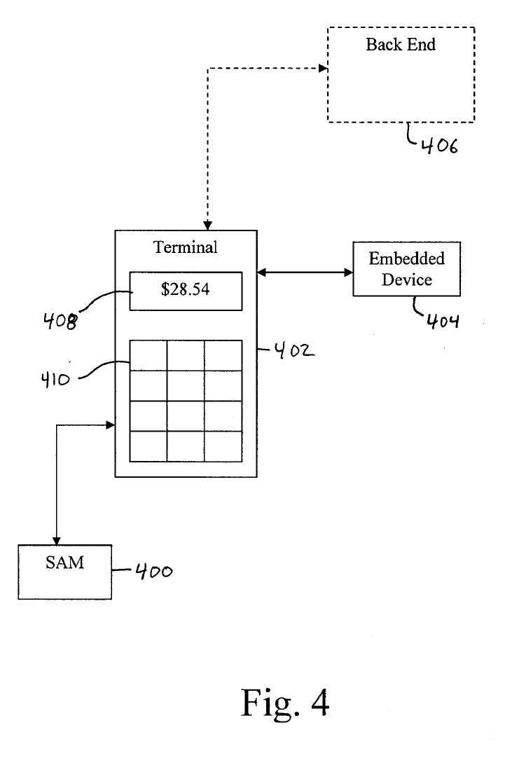

Referring next to FIG. 4, a block diagram is shown illustrating a financial transaction system in accordance with one embodiment. Shown are a SAM 400, a terminal 402, an embedded device 404, a back end 406, a display 408, and a keypad 410.

The SAM 400 is coupled to the terminal 402. The terminal 402 includes the display 408 and the keypad 410. The terminal 402 also optionally includes a slot (not shown) that the embedded device 404 can be inserted into that provides an interface between the terminal 402 and the embedded device 404. For example, metal contacts on the embedded device 404 and in the slot provide input/output (I/O) functions and optionally power to the embedded device 404. In an alternative embodiment, the terminal 402 and the embedded device 404 communicate over a wireless interface.

The embedded device 404 stores account information, account balances, and optionally a personal identification number (PIN) or biometric data used for identification purposes.

In operation, in accordance with one embodiment, during a financial transaction, a merchant will enter an amount for the transaction (e.g., $100) into the terminal 402 using the keypad 410. Optionally, a computer can be coupled to the terminal 402 through an interface and the amount for the transaction is sent to the terminal 402 over the interface. The embedded device 404 is inserted into the slot in the terminal 402 and a user of the embedded device 404 enters a pin number into the terminal 402. In order for a financial transaction to take place the pin number must be verified to confirm the identity of the user of the embedded device 404. The terminal 402 can send the entered personal identification number (PIN) to the SAM 400, the embedded device 404 or the back end 406 for verification. In a preferred embodiment, the verification is done by the embedded device 404 such that a connection to the back end 406 is not required. Generally, the SAM 400 does not have the memory capacity to store a large number of PIN numbers and thus, it is not practical to have the SAM 400 performing the verification. In one preferred embodiment, the PIN is provided to the SAM 400 which creates a secure message that is presented to the embedded device 404 for verification. In an alternative embodiment, biometric data can be used to verify the identity of a user. Exemplary embedded devices using biometric identification are disclosed in U.S. Provisional Patent Application No. 60/806,494, filed Jul. 3, 2006, to Carper et al., entitled BIOMETRIC EMBEDDED DEVICE, which provisional application is incorporated herein by reference in its entirety.

In one embodiment, after entry of the PIN number, the terminal 402 will send an operate command to the SAM 400. Along with the operate command, the terminal 402 will send the SAM 400 some additional information such as the current time, the amount of the transaction and optionally, the PIN number entered by the user. Additionally, public keys for the SAM 400, the embedded device 404 and optionally the back end 406 are exchanged. The SAM 400 packages a message in accordance with the business rules of the financial system and sends a message to the embedded device 404. The content of the message will vary depending upon the financial systems business rules, but include, in one embodiment, the amount of the transaction and the PIN number entered by the user. The message is encrypted using the public key of the embedded device 404. Additionally, a signature is attached to the message that is encrypted using the private key of the SAM 400. Thus, the embedded device 404 is the only device capable of reading the message and the embedded device 404 can verify that the message came from the SAM 400. The message also includes routing information that has not been encrypted such that the terminal 402 is able to properly route the message to the embedded device 404. While the terminal 402 can read the routing information, the terminal 402 can not read the message and does not know the content of the message.

The embedded device 404 receives the message, decrypts the message and executes the business rules located on the embedded device 404. The business rules will vary depending on the financial systems requirements, the amount of the transaction, and potentially many other factors. In one embodiment, the business rules include, for example, verifying the amount of the transaction is less that or equal to an account balance and verifying that the pin number is correct. The embedded device 404 then sends an encrypted message to the SAM 400 using the public key of the SAM 400. The terminal 402 routes the message to the SAM 400.

The SAM 400 will then decrypt the message and again run any business rules. As stated above, the business rules will vary depending upon the system. The SAM 400, for example, determines if the transaction should be approved. Alternatively, the SAM 400 can send message back to the embedded device 404 or can send a message to the back end 406. Upon final authorization or rejection, a message is sent to the terminal 402 informing the terminal if the transaction has been approved or rejected.

In another embodiment, the operation of the system can proceed as follows. The terminal 402 coupled to the SAM 400 detects the insertion of an embedded device 404 (e.g., a smart card). The Terminal 402 then creates and sends a message to the SAM 400 requesting that the SAM 400 determine whether the requested operation is authorized or not. The SAM 400 prepares a message that is sent to the smart card 404. The smart card 404, upon receiving the message, determines if the message is part of the enterprise to which the smart card belongs. If the smart card 404 is authorized to function in the system containing the SAM 400, then the smart card 404 proceeds to determine if there are any rules contained within the smart card 404 which are applicable to the request sent by the SAM 400.

After processing any rules that are applicable, the smart card 404 creates a message targeted for the SAM 400 (or another secure device, like the secure back-end 406) containing relevant information for the requested transaction. The message is then delivered to the terminal 402 whereby the terminal 402 will redirect and deliver the message to the appropriate device. The process of evaluating the received message and generating a new message to be forwarded continues between the devices in the system until an authorized secure device determines that the process has been completed to a point where final authorization can be determined. Once final authorization has been determined, a message is generated which is destined for the terminal 402 to inform the terminal 402 if the specified operation has been authorized or not.

Referring to FIG. 5, a block diagram is shown illustrating an access control transaction system in accordance with one embodiment. Shown is a SAM 500, a locking terminal 502, an embedded device 504, a back end 506, a secured area 508 and a door 510.

The locking terminal 502 (also referred to herein as the terminal 502) and SAM 500 are, for example, located within a room or a secure area 508. The locking terminal 502 controls a lock to the door 510 or otherwise controls access to the room or secure area 508. The locking terminal 502 can control the operation of an electromechanically operated door or gate. While the locking terminal 502 may actually send a signal that opens the lock to the door 510 or opens the electromechanically operated door or gate, the SAM 500 and optionally the embedded device 504 contain all the business logic for determining when the terminal 502 will be allowed to operate. That is, the SAM 500 will instruct the terminal 502 to unlock or open the door 510 and the terminal 500 will perform any required operations to carry out the instruction. The back end 506 is optionally included in the access control system and can provide an added level of security and confirmation before unlocking the door 510. The back end 506 can include video screens, computers, and personnel, such as is known in the art for high security environments.

In operation, in accordance with one embodiment, the locking terminal 502 and the SAM 500 are powered on. By default, the door 510 will be locked, thus preventing access to the secured area 508. The terminal 502 waits for the embedded device 504 to come into communication with the terminal 502 (e.g., be inserted to an interface that is located outside of the secured area or come into communication through a wireless interface). For the remainder of the exemplary operation, it will be assumed that the embedded device 504 is inserted into an interface to the terminal 502. After the embedded device 504 is inserted into the interface, the terminal 502 sends an “operate” command to the SAM 500. Additional information is also optionally sent to the SAM 500 including, for example, the time of day. Optionally, during the process, the SAM 500 and the embedded device 504 exchange public key information.

The SAM 500 will next create a message for the embedded device 504. The SAM 500 creates the message based upon business logic located on the SAM 500 and the information received from the terminal 502. The message is encrypted using the public key of the embedded device 504 and sent to the terminal 502. The message includes an unencrypted routing portion that the terminal 502 can read and also optionally includes a signature such that the embedded device 504 can ensure that the message was sent by the SAM 500. The unencrypted routing portion of the message allows the terminal 502 to properly route the message. By design, the terminal 502 does not know the content of the message and does not make any decisions about the message other that to properly route the message to the embedded device 504.

The embedded device 504 receives the message and executes its own business logic based upon the content of the message. In a preferred embodiment, the SAM 500 and the embedded device 504 always execute their own business logic and make their own decision about what the next step in the process flow should be. That is, the SAM 500 and the embedded device 504 are generally not responding to requests, but are accepting command and control information and then actively making decisions according to the business logic of the device. This is in contrast to prior systems where the terminal 502 contains all the business logic and sends requests to the SAM 500 and the embedded device 504 that are responded to. In prior systems, the terminal 502 contains the business logic. As described above in the background, there are many bad consequences in having the terminal implement the business logic of the system. In an alternative embodiment, the embedded device may deliver its rules, in an encrypted manner to the SAM for processing and validation.

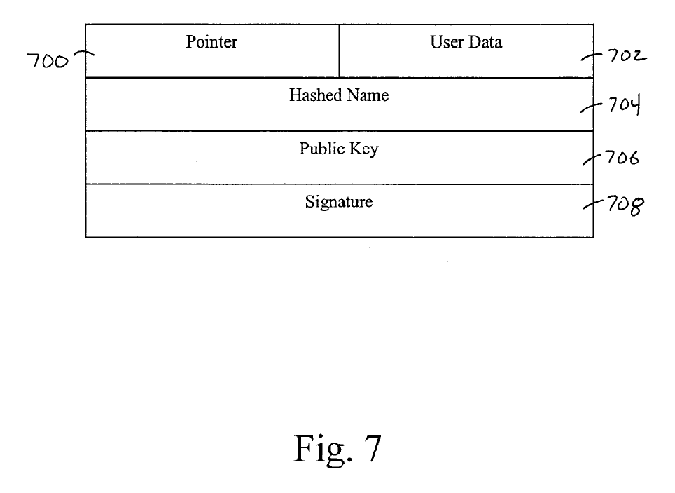

In accordance with one embodiment, after executing the business logic, the embedded device 500 encrypts a message using the public key of the SAM 500. The message is routed through the terminal to the SAM 500. Upon receipt, the SAM 500 again performs its business logic to verify the embedded device 504 and determine if the door 510 should be opened. If so, the SAM 500 will send a message intended for the terminal 502 that will proceed to unlock or open the door 510. In an alternative embodiment, the SAM 500 may generate a message for the back end 506 that would then confirm access should be granted. It should be understood that the system is very flexible and that the business logic can be easily updated to incorporate new procedures for granting access without having to make any changes to the terminal. This will be further described in greater detail below with reference to FIGS. 7-10.

In accordance with some embodiments, regardless of whether access is granted or not, the SAM 500 sends a receipt to the terminal to memorialize the transaction. The receipt includes both encrypted and unencrypted components and optionally includes a digital signature as well as information identifying the particular embedded device 404 taking part in the transaction.

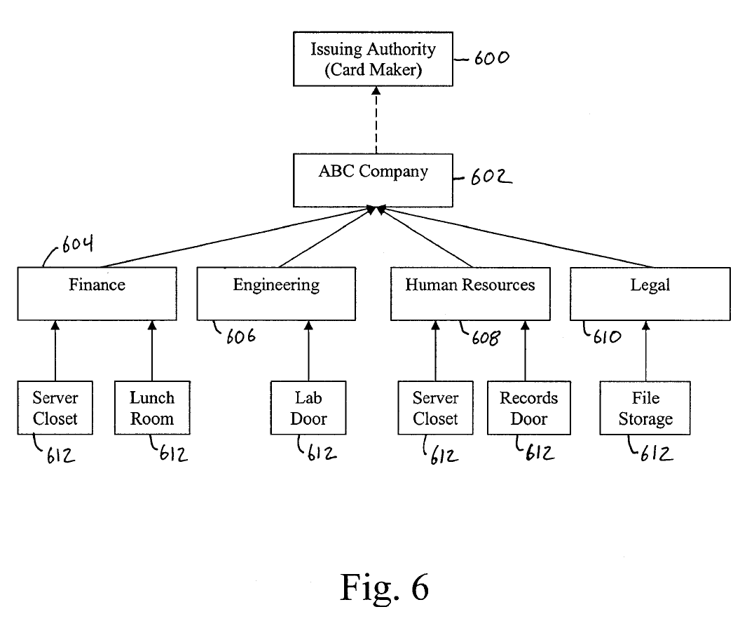

It should be understood that while only one terminal is shown, the access control system can include many terminals to control access to any number of doors within a large facility (including remote or satellite locations). This capability will be further described below with reference to FIG. 6.

As described above, the current embodiments can be implemented in a sessionless environment. One example of a system where a sessionless system is beneficial is in a security environment that is controlled by a two door entry system. That is, in order to gain access to a secured area, a person must gain access through two doors in succession before they will get into the secured area.

In existing systems, a person presents credentials to obtain authorization to the first door. The back-end system (or some other intermediate system) is utilized to remember that access was granted. Subsequently, when the person attempts access to the second door, the back-end (or other intermediate system) confirms authorization to the second door and also confirms that authorization was granted to the first door—the confirmation of access to the first door is performed to ensure the person did not gain access to the second door by some other means (like climbing over the wall).

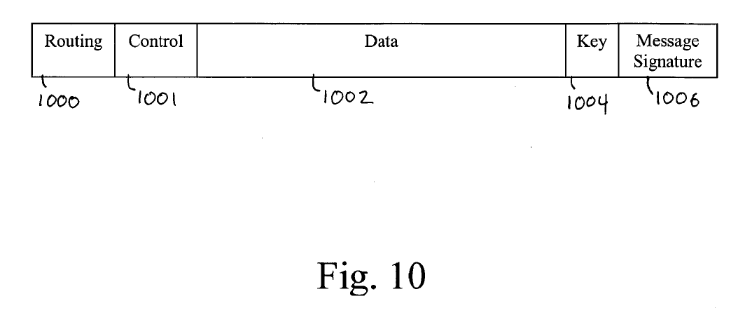

In accordance with the present embodiment, in operation, an embedded device is coupled to a terminal that controlled the first door. The embedded device, the SAM, and optionally the back end would send messages back and forth according to the business logic for the specific system. If the embedded device had the proper access rights, the SAM or the back end will eventually send a command to the terminal instructing the door to be opened. A message can then be sent from the SAM or the back end to a second SAM or second terminal located at the second door. The message can wait at the second SAM or the second terminal until the embedded device is coupled to the second terminal. At this time, the message can be sent to the embedded device which proceeds to process the command in accordance with the business logic located on the embedded device. Eventually, if the access rights of the embedded device are verified, the second door will be opened by the second terminal. In this implementation, the back end does not need to keep track of what has previously taken place at the first door. An exemplary message format that can be utilized in a sessionless system is described below with reference to FIG. 10.

Referring to FIG. 6, a diagram is shown illustrating a hierarchy within the access control transaction system shown in FIG. 5 in accordance with one embodiment. Shown is an issuing authority 600, a company authority 602, department authorities that include a finance authority 604, an engineering authority 606, a human resources authority 608, and a legal authority 610. Also shown are lower level authorities 612 within each of the department authorities.

Shown in FIG. 6 are arrows that point upward to indicate that the farther up the diagram, a higher authority is being represented. The issuing authority 600 is generally the company that initially manufactures and distributes cards (i.e., embedded devices) to a company (e.g., ABC company). Once the issuing authority 600 initializes the cards for the top level authority within the company (i.e., the company authority 602), the company authority has the capability to sever the link between the company authority 602 and the issuing authority 600. As indicated by the dashed arrow, this allows ABC company to prevent the issuing authority 600 from being able to gain access to the access control system of ABC company. This is beneficial for both the issuing authority and ABC company. Optionally, the company authority 602 has the ability to “turn back on” the issuing authority's 600 access, for example, for debugging or maintenance requirements.

The hierarchical structure shown provides for a means to prevent the entire access system from being compromised, provides for greater design flexibility and also provides for a manner in which any embedded device can be verified through an issuing certificate located on the embedded device. If the embedded device to be verified can not be verified through a particular level authority, the certificate can simply be passed up to a higher authority until one of the authority levels can authenticate the embedded device. The company authority 602 will usually be able to authenticate any device used in the system. As an example, if an embedded device that is part of the human resources authority level is attempting to gain access to the engineering authority, the company authority will need to verify the identify of the embedded device.

However, if an embedded device within the finance department is trying to access a door that is under the finance authority 604, the company authority 602 does not have to verify the embedded device because the finance authority can do so. In this manner, the system can many times grant access to an area without the need to verify the embedded device with a back end or higher authority.

Referring to FIG. 7, a diagram is shown illustrating a structure of a preferred access block within the hierarchy of the access control transaction system shown in FIG. 6 in accordance with one embodiment. Other structures for access blocks are utilized in other embodiments. Shown is a pointer 700, user data 702, a hashed name 704, a public key 706 and a signature 708.

The pointer 700 is directed (i.e., points) to another access block to create a continuing linked list of access blocks. The end of such list is identified by a pointer having a value of 0 or null. The user data 702 contains any information desired for the specific implementation which is descriptive regarding the purpose of the access block. While being binary data in nature, this information has no specific usability requirement but may serve a useful purpose when information is reported to a logging or reporting service. In accordance with one embodiment, the user data 702 also contains information to better identify the access block which was utilized. The hashed name 704 is a 20 byte hashed representation of the complete hierarchical path structure as shown in FIG. 6. The human readable path is, for example, the following:

Issuer:ABC_Company:Engineering:Lab_Door. The corresponding hashed value for the human readable path could be, for example, the following: A4E83D2BBC84E1F90CBE. The public Key 706 is a public key value that is utilized by this specific access block. Other access blocks may utilize the same or different public key. The signature 708 element contains the digital signature of an approved signing authority somewhere higher in the hierarchy of the path to this access block.

Other structures for the access block may be used in accordance with various embodiments.

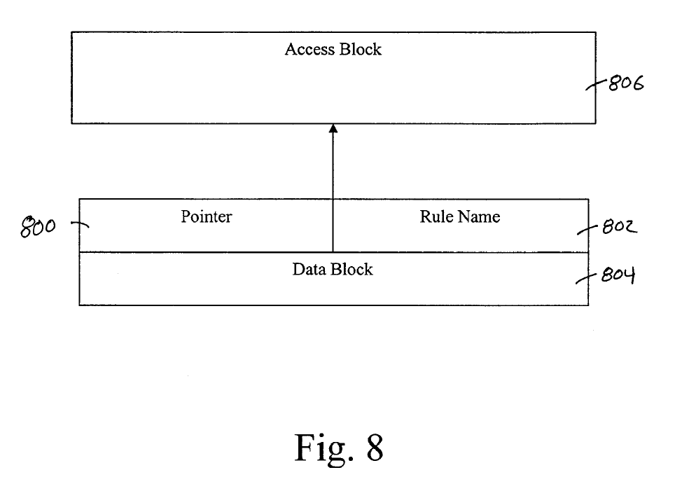

Referring to FIG. 8, a diagram is shown illustrating a rule for the access block shown in FIG. 7 in accordance with one embodiment. Shown is a pointer 800, a rule name 802, a data block 804 and an access block 806.

The pointer 800 is directed to the access block 806 which is, for example, one of the access blocks shown above with reference to FIGS. 6 and 7. In accordance with one embodiment, the pointer is generally assigned 2 bytes, thus, for any system there can be 2¹⁶ different access blocks. This lends to great flexibility and expandability within the system. The rule name 802 is, for example, also 2 bytes, thus allowing for the total number of rules for each block to be 2¹⁶ again allowing for great flexibility within the system. Rule “naming” is involved. The “name” of the rule to be evaluated is calculated from a combination of the contents of the received message including the value of the one byte command identifier and the value of the encryption status byte. In addition, card or SAM specific rules, if present and selected by the routing information for the received message, override any generic rules which may exist with the same name. Furthermore, provision exists to select one of several rules with the same name but with a different one byte subkey value. If no subkey is included in the command message it is assumed to be zero. One feature of the system being described is that, in the case of the SAM for example, an unencrypted “Operate” command from the terminal selects a different rule to be evaluated than an encrypted “Operate” command from a card.

The data block 804 can be any length, can contain most any amount of data, and can be used for many different purposes and by different applications. Rules (also referred to herein as business rules) can be added to the access block at any time so long as the rule comes from a provably trusted source (e.g., an issuing authority) that has authority over the access block 806. In this manner, the rules of the system can be changed or updated at any time. The data block 804, in accordance with one example, embodies a subset of the ISO 8824 ASN. 1 (Abstract Syntax Notation, One) Tag, Length, Value (TLV) data structure. This adds great flexibility to the type of data the rule can be. The Tag identifies what type of data the Value is. The Length value identifies the length (in bytes) of the Value and may not be present at all if the length can be known from the type of the data. The rule can be, for example, human readable, cryptic symbols, source code, or any other data.

The business rules can have many different types of inputs that are acted upon within the rules. In accordance with one embodiment, inputs to the SAM 500 include: 1) the “operate” command from the terminal, 2) a 32 bit data and time stamp, 3) a time of day (second since midnight local time), 4) a day of week local time, 5) user data from a certificate that is issued by Issuing Authority, 5) a bit table (described below with reference to FIG. 9), and 6) any other data that may be useful in a access control system (e.g., biometric data). The SAM 500 will receive any of this information either from the terminal, the embedded device 504 or the back end 506, and depending upon the business rules, will act upon one of more of the pieces of data.

Referring to FIG. 9, a diagram is shown illustrating a bit table 900 for use in the access control transaction system shown in FIG. 5 in accordance with one embodiment. The bit table 900 includes 8 bits in the present embodiment; however, other numbers of bits can be utilized depending upon the requirements of the access control transaction system. Additionally, the bit table is one example of a data structure that can be utilized to communicate data between devices in a transaction system. Other types of data structures are utilized in alternative embodiments. The bit table can be sent back and forth from the SAM 500 and the embedded device 504 (and optionally the back end 506) in order to communicate information from one device to another. The business rules within the SAM 500 and the embedded device 504 are used to manipulate the bit table. The following is an exemplary scenario for using the bit table 900 in the access control transaction system.

Upon receiving an “operate” command from the terminal 502, the SAM 500 will set the bit table 900 to all zeros using a business rule. Next the SAM 500 will send an encrypted message to the embedded device 504 that includes a date, a current time, an ID of the door, and the bit table 900. Upon receipt of the message, the embedded device 504 executes its own business rules and can modify any of the bits in the bit table 900 according to the business rules. For example, the embedded device 504 can set bit 5 indicating that, for example, the user of the embedded device 504 is a manager. Additionally, if the ID of the door is associated with, for example, the finance group, the card will set bit 2. As can be seen, there are many possibilities for setting different combinations of bits. The embedded device 504 will then package a message including the updated bit table 900 and send an encrypted message back to the SAM 500. The SAM 500 will update the bit table 900 according to the message and execute its own business logic to determine if the door should be opened. At this point the SAM 500 can also send a message to the back end 506 asking for verification before opening the door. The above is one example of a data structure that can be operated on by the SAM 500 and the embedded device 504 and used to determine whether access should be granted within an access control system.

Referring again to FIG. 5 as an example, when two electronic devices (e.g., the SAM 500, the embedded device 504 or the back end 506) are communicating, an access table (e.g., a bit table) is sent, encrypted, as part of the message back and forth in accordance with one embodiment. The access table is copied into RAM so that it can be accessed and modified. Additionally, the two electronic devices have no expectations as to what is present in the table. As messages are exchanged, the electronic devices execute the rules and update the table accordingly. In accordance with one embodiment, the SAM ultimately keeps the access table in RAM so that if power is lost the RAM based table is lost and effectively reset thus ensuring that the door will not open without proper authorization.

If the access table were stored in persistent (EEProm or flash or disk) storage, it could be possible for an attacker to remove the SAM and utilize it in another door. In such a case, the attacker would first require access to both doors from the inside and their SAMs, but once access was gained, the SAMs could be swapped between the two doors to avoid detection but the end result could allow a second attacker to now have access to a physical door not previously accessible.

Referring to FIG. 10, a diagram is shown illustrating a message block used in a transaction system in accordance with one embodiment. The message block includes a routing portion 1000, a data portion 1002, a key 1004 and a signature 1006. In accordance with one embodiment the message block is the structure of the messages that are sent between the SAM, the embedded device, and the back end in any of the systems described above. Other structured data blocks may be used in accordance with various embodiments; however, the present example can be utilized to provide very secure transmissions.

The routing information 1000 is unencrypted that the terminal can read and is used by the terminal to properly route messages between the various devices within the system. In accordance with one embodiment, the routing information includes T (terminal), E (back end), C (embedded device or card) or S (SAM). Other schemes for the routing information can be used.

The control section 1001 selects or indicates whether the data portion 1002 is encrypted and whether the message will include a signature.

The data portion 1002 is an encrypted data structure that is structured in accordance with the TLV structure described above. This enables the data portion to be very flexible, thus allowing for a variety of different messages to be sent within a transaction system.

The key 1004 is used to encrypt the data portion 1002. The key is required to decrypt the data portion 1002. The key 1002 is also encrypted using the public key of the device the message is destined for.

The signature 1006 is a digital signature that is used to verify the content of the entire message and to verify where the message came from. A mathematic operation is run over at least the data portion and the routing portion of the message block in order to generate a number. The number is then encrypted by using the sender's private key. Thus, the destination device can decrypt the number using the sender's public key and thus, verify that the message came from the sender. Additionally, because the routing information is included in the mathematical operation, the destination device can verify that the routing information was not changed and that the message was correctly routed.

The key 1004 and the signature 1006 may or may not be present based upon the value of the control section 101. For example, the key 1004 and the signature 1006 are absent in unencrypted and unsigned message from the terminal to the SAM.

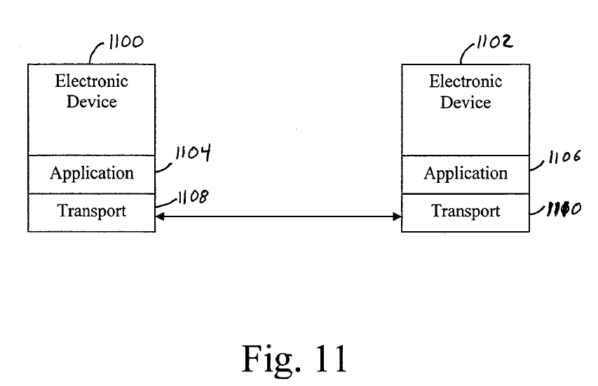

Referring to FIG. 11, a diagram is shown illustrating a system for encrypted communication in accordance with one embodiment. Shown is a first device 1100, a second device 1102, a first application layer 1104, a second application layer 1106, a first transport layer 1108, and a second transport layer 1110.

The first device 1100 includes the first application layer 1104 and the first transport layer 1108. The second device 1102 includes the second application layer 1106 and the second transport layer 1110.

In prior systems, either the application layers or the transport layers would do the encryption and the decryption. That is, when the first application layer 1104 encrypted a message, the second application layer 1106 would decrypt the message. Similarly, when the first transport layer 1108 would encrypt a message the second transport layer 1110 would decrypt the message. This works fine in systems where the entire message can be stored into memory and encrypted (such as computers having a large amount of memory resources). However, such a scheme may not work in some applications such as the secure transaction systems described in the present application and in other types of systems with typically reduced memory resources.

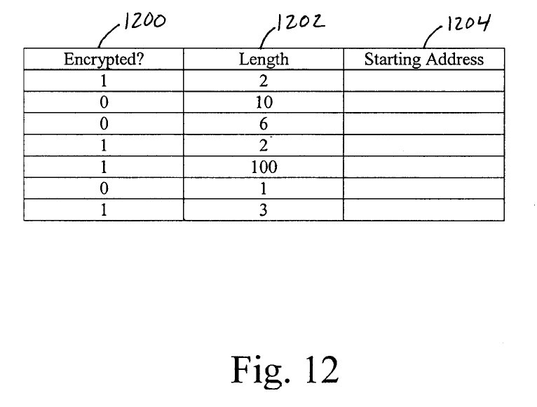

In accordance with one embodiment, the first application layer 1104 creates a table that includes a list of addresses (location of data) that will be sent to the second device 1102. The table also includes a designation for whether the data for each location should be encrypted or not. An exemplary table is shown in FIG. 12 and described below.

The first transport layer 1108 receives the table and sends the data listed in the table (encrypted or unencrypted) to the second transport layer 1110. The data is sent in portions and not as one large encrypted data block. Once received, the data is stored in a memory of the second device 1102. Following, the second application layer 1104 decrypts the portions of the stored data that have been encrypted. The second transport layer 1110 does not include information about whether the data is encrypted or unencrypted in the data stream. This method of encrypted communication prevents the need to write a large amount of data to memory which greatly increases the limited life of the memory within the SAM and embedded devices described above.

Referring to FIG. 12, a diagram is shown illustrating a table for use in the system shown in FIG. 11 in accordance with one embodiment. Shown is an encryption column 1200, a length column 1202 and an address column 1204.

The address column 1204 indicates to a transport layer the starting address location of data stored on a first device that is going to be sent to a second device.

The length column 1202 indicates the length of the data that is going to be sent to the second device.

The encryption column 1200 indicates to a transport layer whether the data stored on the first device is going to be encrypted or unencrypted when sent to the second device.

Various embodiments have been described in detail herein. The following paragraphs provide some examples of various features and some advantages of some of the embodiments described herein.

In some embodiments, an overall “permission hierarchy of ownership” exists, the format of which is not defined by rules but allows for the addition of new levels and objects within those levels. Thus, each “issuing authority” only controls those objects (and subordinate “issuing authorities”) it directly creates. The issuing authority, however, can not modify its own parameters.

In some embodiments, the system provides the ability to enforce “three factor authentication (something you _are_(fingerprint), something you _know_(PIN), something you _have_(the card itself))”.

Additionally, in some embodiments, the system provides the ability to enforce “authorization” based upon “signed credentials” (stored as “certificates”) created by “issuing authorities” using strong cryptography.

Rules, for example, are descriptions of actions or conditions that may be embodied in any form convenient for the specific implementation. For example, binary code, java code, basic, or other languages, or computer descriptive systems designed for a specific industry.

In one embodiment, certificates include a (humanly readable) name, hashed path, public key, (encrypted) private key, and 8-bytes of user data all digitally signed by (under the private key from the certificate of) the parent issuing authority.

In one embodiment, data objects include a (humanly readable) name, hashed path, and flexible user data. Rules are un-named and can be associated with objects and certificates. Rules are evaluated starting with the object and then for each certificate encountered up the path to the root. For each operation, this takes place first on the SAM, then on the card, then AGAIN on the SAM. While an exact match for a specific object on the SAM might not exist on a given card, the rules associated with any matching certificates in the shared path of issuing authorities will be evaluated (e.g., “dept master keys”). Rules can define both the content and format of both messages and data objects. In general, the format of credentials and rules is largely fixed. In another embodiment rules are evaluated from the root level down to the specific data object.

In some embodiments, rules operate on several sources of input operands (“symbolically addressable” by their TLV tags embedded within TLV tagged “blocks”):
1) symbolically addressable items in the (unencrypted) command message from the terminal,
2) symbolically addressable items in the (encrypted) messages from “the counterpart device” or back end,
3) internal data structures in RAM (e.g., the “bit table”),
4) symbolically addressable items in the data object itself (e.g., counters or “balances” in a lock, key, or “purse”),
5) symbolically addressable items in the parent certificates, (e.g., “user data”),
6) “immediate” values within the rules themselves (e.g., starting and/or ending “seconds since midnight, local time”).
   Rule operands are manipulated by operators which include a built-in library of the most common operations plus the ability to add (and execute) new rules “in the field”.

TLV Blocks can contain other subordinate blocks. They can have a length or bounded by an END-BLOCK. Some of the types of blocks include: Command and Response, Identity (including unique hardware ID and public key), Path (including hashes from object to root), and Certificate, Object, and Ruleset.

In some embodiments, the kinds of data can include: Strings (binary 8-bit bytes with 16-bit counted length), Unsigned (8 bit) byte, (16-bit) word, 32-bit signed long, Signed (8 bit) byte, (16-bit) word, 32-bit unsigned long, certificate “User Data String,” 8-byte “unique hardware ID,” 16-byte 3DES key, TBD “key split,” 32-byte SHA-256 hash (used for message signatures), 128-byte RSA-style 1024-bit public and private keys, and 128-byte signatures.

The types of data can include: 32-bit UTC time in seconds, 32-bit signed balances and counts, name strings, command identifiers, subkeys, and statuses.

While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

We claim:

1. A secure transaction system comprising:
a terminal;
a secure access module coupled to the terminal, wherein the secure access module includes a first set of business rules for performing a transaction; and
a secure embedded device coupled to the terminal during the transaction,
wherein the embedded device includes a second set of business rules for performing the transaction;
wherein the terminal routes messages between the secure access module and the secure embedded device.

2. A secure transaction system comprising:
a terminal;
a secure access module coupled to the terminal; and
an secure embedded device coupled to the secure access module during a transaction;
wherein the business logic for controlling flow of the transaction is contained on the secure access module and the secure embedded device.

3. A method of performing a secure transaction comprising:
detecting a secure embedded device that has been coupled to a terminal;
sending an operate command from the terminal to a secure access module;
executing, at the secure access module, a first set of business rules and generating a first message for the secure embedded device, wherein the first message is at least partially encrypted;
sending the first message to the secure embedded device;
executing, at the secure embedded device, a second set of business rules in response to receiving the first message and generating a second message for the secure access module, wherein the second message is at least partially encrypted; and
sending a command from the secure access module to the terminal indicating to the terminal to perform an intended function.

4. The method of performing a secure transaction of claim 3 further comprising:
executing at the secure access module, an additional set of business rules; and
evaluating any conditional rules to determine if the intended function is to be allowed.

5. A method of updating a secure embedded device in a transaction system comprising:
coupling a secure access module to a terminal;
coupling a secure embedded device to the terminal; and
receiving a message from the secure access module at the secure embedded device; and
updating at least one business rule of the secure embedded device in response to receiving the message.

6. The method of claim 5 further comprising completing a transaction in accordance with the updated business rule.

7. A method of updating a secure access module in a transaction system comprising:
coupling the secure access module to a terminal;
coupling a back end to the terminal; and
receiving a message from the back end at the secure access module; and
updating at least one business rule of the secure access module in response to receiving the message.

8. The method of claim 7 further comprising completing a transaction in accordance with the updated business rule.

9. A method of updating a device in a transaction system comprising:
coupling a secure access module to a terminal;
coupling a secure embedded device to the terminal;
receiving a message from the secure embedded device; and
updating at least one business rule of the secure access module in response to receiving the message.

10. The method of claim 9 further comprising coupling a back end to the terminal.

11. A method of updating a device in a transaction system comprising:
coupling a secure access module to a terminal;
coupling a secure embedded device to the terminal;
receiving a message from the secure access module; and
updating at least one business rule of the secure embedded device in response to receiving the message.

12. The method of claim 11 further comprising coupling a back end to the terminal.

13. A method of updating a device in a transaction system comprising:
coupling a secure access module to a terminal;
coupling a secure embedded device to the terminal;
coupling a back end to the terminal; and
receiving a message from the back end at the secure embedded device; and
updating at least one business rule of the secure embedded device in response to receiving the message.

14. The method of claim 13 further comprising completing a transaction in accordance with the updated business rule.

15. A method of communication comprising:
creating a data structure in a first application layer, the data structure indicating to a first transport layer a list of addresses that correspond to data stored in a first device and an indication of whether the data located at the list of addresses will be sent to a second transport layer in encrypted or unencrypted form;
sending the data in the list of addresses from the first transport layer to the second transport layer in unencrypted or encrypted form as indicated in the data structure;
storing the data sent from the first transport layer in memory of a second device; and
decrypting the data in a second application layer.
